(19) United States
(12) Patent Application Publication
(10) Pub. No.: US 2011/0119701 A1
(43) Pub. Date: May 19, 2011

(54) COORDINATED VIDEO FOR TELEVISION DISPLAY

(75) Inventor: Kevin M. Crucs, Copley, OH (US)

(73) Assignee: CRUCS HOLDINGS, LLC, Copley, OH (US)

(21) Appl. No.: 12/711,511

(22) Filed: Feb. 24, 2010

Related U.S. Application Data
(63) Continuation-in-part of application No. 12/621,772, filed on Nov. 19, 2009.

(51) Int. Cl. H04N 7/025; G06F 17/30; H04N 5/445; H04N 5/44

(52) U.S. Cl. 725/32; 707/769; 707/706; 725/53; 348/734; 707/E17.108; 348/E05.096

(57) ABSTRACT

Apparatus, methods, and systems for acquiring search content based on digital information content provided from a video source. Video information and associated non-video information are received from a video source. The video information includes program video content and the associated non-video information includes digital information content. At least a portion of the digital information content is transformed into a search query and the search query is communicated to a first search data source. A query result is received from the first search data source based on the search query. At least a portion of the search query results are transformed into query result display data which may then be encoded as a video signal for display.

This U.S. patent application is a continuation-in-part (CIP) of and claims the benefit of and priority to U.S. patent application Ser. No. 12/621,772 filed on Nov. 19, 2009 which is incorporated herein by reference in its entirety.

### TECHNICAL FIELD

Certain embodiments of the present invention relate to displaying digital information content. More particularly, certain embodiments relate to displaying video content from a standard television source and search query results based on digital information associated with the video content.

### BACKGROUND

Digital television broadcast signals encode program video and audio along with digital information associated with a television program. When a digital television broadcast signal is received by a digital television set, the encoded digital information may be displayed overlaying the video content, for example, by selecting an “info” button on a remote control associated with the digital television set. The displayed digital information may or may not encompass information that a user finds useful. A user may desire to view other information related to the program and its associated encoded digital information.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention comprises an apparatus for acquiring search content based on digital information content provided from a video source. The apparatus includes means for receiving video information and associated non-video information from a video source. The video information includes program video content and the associated non-video information includes digital information content. The apparatus further includes means for processing the digital information content to generate a search query, and means for communicating the search query to a first search data source. The apparatus also includes means for receiving at least one query result from the first search data source based on the search query. The apparatus may further include means for parsing the digital information content from the video information and associated non-video information, for example, when the video information and associated non-video information is a digital video data channel having a digital video sub-channel encoded with the program video content and a digital information sub-channel encoded with the digital information content. The apparatus may further include means for processing the at least one query result to generate query result display data, and means for generating a query result video signal encoded with the query result display data. The apparatus may also include means for outputting the query result video signal and means for outputting a program video signal having the program video content. The program video signal may include a video data channel received from the video source as the video information and associated non-video information. Alternatively, the program video signal may be derived from a video data channel received from the video source. The apparatus may further include means for displaying the program video signal and the query result video signal, for example, on separate displays. Alternatively, the apparatus may include means for combining the program video signal and the query result video signal into a single composite video signal, and means for displaying the single composite video signal, for example, on a single display. The apparatus may also include means for receiving remote control commands from an external remote control device.

Another embodiment of the present invention comprises a method for acquiring search content based on digital information content provided from a video source. The method includes receiving video information and associated non-video information from a video source. The video information includes program video content, and the associated non-video information includes digital information content. The method further includes transforming at least a portion of the digital information content into a search query and communicating the search query to a first search data source. The method also includes receiving at least one query result from the first search data source based on the search query. The method may further include parsing the digital information content from the video information and associated non-video information, for example, when the video information and associated non-video information is a digital video data channel having a digital video sub-channel encoded with the program video content and a digital information sub-channel encoded with the digital information content. The method may also include transforming at least a portion of the at least one query result into query result display data, and generating a query result video signal encoded with the query result display data. The method may further include outputting the query result video signal, and outputting a program video signal having the program video content. The program video signal may include a video data channel received from the video source as the video information and associated non-video information. Alternatively, the program video signal may be derived from a video data channel received from the video source. The method may further include displaying the program video signal and the query result video signal on two separate displays. The method may alternatively include combining the program video signal and the query result video signal into a single composite video signal, and displaying the single composite video signal, for example, on a single display. The method may also include remotely influencing the transforming of the digital information content into a search query via a remote control device.

A further embodiment of the present invention comprises a system for acquiring search content based on digital information content encoded in a digital video data channel. The system includes a digital television (DTV) receiver capable of receiving a digital television broadcast signal and demodulating the digital television broadcast signal to extract a digital video data channel. The digital video data channel includes a digital video sub-channel encoded with digital video content and a digital information sub-channel encoded with digital information content. The system further includes a parsing search engine (PSE) operatively connected to the digital television receiver and capable of receiving the digital video data channel, generating a search query based on the digital information content, and receiving at least one query result based on the search query. The system also includes a video coordinator and controller (VCC) operatively connected to the parsing search engine and capable of receiving a digital video signal and a query result video signal from the parsing search engine. The digital video signal is encoded with the digital video content and the query result video signal is encoded with at least a portion of the at least one query search result. The VCC is further capable of generating a composite video signal from the digital video signal and the query result video signal. The system may further include a first search data source operatively connected to the parsing search engine and capable of providing the at least one query result based on the search query. The system may also include an intermediate search data source operatively connected between the parsing search engine and the first search data source and capable of passing the search query from the parsing search engine to the first search data source, editing the at least one query result received from the first search data source to generate an edited query result, and providing the edited query result to the parsing search engine. The system may also include a display device capable of receiving and displaying the composite video signal. The system may further include a remote controller device capable of allowing a user to remotely control at least one of the parsing search engine (PSE), the video coordinator and combiner (VCC), and the digital television (DTV) receiver. The digital television receiver may include one of a digital terrestrial television receiver, a digital cable television receiver, a digital satellite television receiver, a digital microwave television receiver, and an internet protocol television receiver.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a schematic block diagram of a system having a first embodiment of a video coordinator and combiner (VCC) apparatus for generating coordinated video content for display, and showing a first example embodiment of a coordinated video display partition or format;

FIG. 2 illustrates a second example embodiment of a coordinated video display partition or format;

FIG. 3 illustrates a third example embodiment of a coordinated video display partition or format;

FIG. 4 illustrates a fourth example embodiment of a coordinated video display partition or format;

FIG. 5 is a flowchart of a first embodiment of a method for generating coordinated video content for display using the VCC of FIG. 1;

FIG. 6 illustrates a schematic block diagram of a system having a second embodiment of a video coordinator and combiner (VCC) apparatus for generating coordinated video content for display;

FIG. 7 illustrates a schematic block diagram of a system having a third embodiment of a video coordinator and combiner (VCC) apparatus for generating coordinated video content for display;

FIG. 8 is a flowchart of a second embodiment of a method for generating coordinated video content for display using, for example, the system of FIG. 6 or the system of FIG. 7;

FIG. 9 illustrates a schematic block diagram of an embodiment of the VCC of FIG. 1;

FIG. 10 illustrates an embodiment of a method of selecting a portion of an auxiliary video content for display along with a standard television video content;

FIG. 11 illustrates a video display having a selected auxiliary video content portion, and the remaining portion of the video display having a standard television video content portion as a result of the method of FIG. 10;

FIG. 12 illustrates a schematic block diagram of a first embodiment of a system for acquiring search content based on digital information content provided from a video source;

FIG. 13 is a flowchart of an embodiment of a method for acquiring search content based on digital information content provided from a video source;

FIG. 14 illustrates a schematic block diagram of an embodiment of a parsing search engine used in the system of FIG. 12;

FIG. 15 illustrates a schematic block diagram of a second embodiment of a system for acquiring search content based on digital information content provided from a video source;

FIG. 16 illustrates a schematic block diagram of a third embodiment of a system for acquiring search content based on digital information content provided from a video source;

FIG. 17 illustrates a schematic block diagram of a fourth embodiment of a system for acquiring search content based on digital information content provided from a video source;

FIG. 18 illustrates a schematic block diagram of a fifth embodiment of a system for acquiring search content based on digital information content provided from a video source;

FIG. 19 illustrates a schematic block diagram of a sixth embodiment of a system for acquiring search content based on digital information content provided from a video source; and

FIG. 20 illustrates a schematic block diagram of a seventh embodiment of a system for acquiring search content based on digital information content provided from a video source.

### DETAILED DESCRIPTION

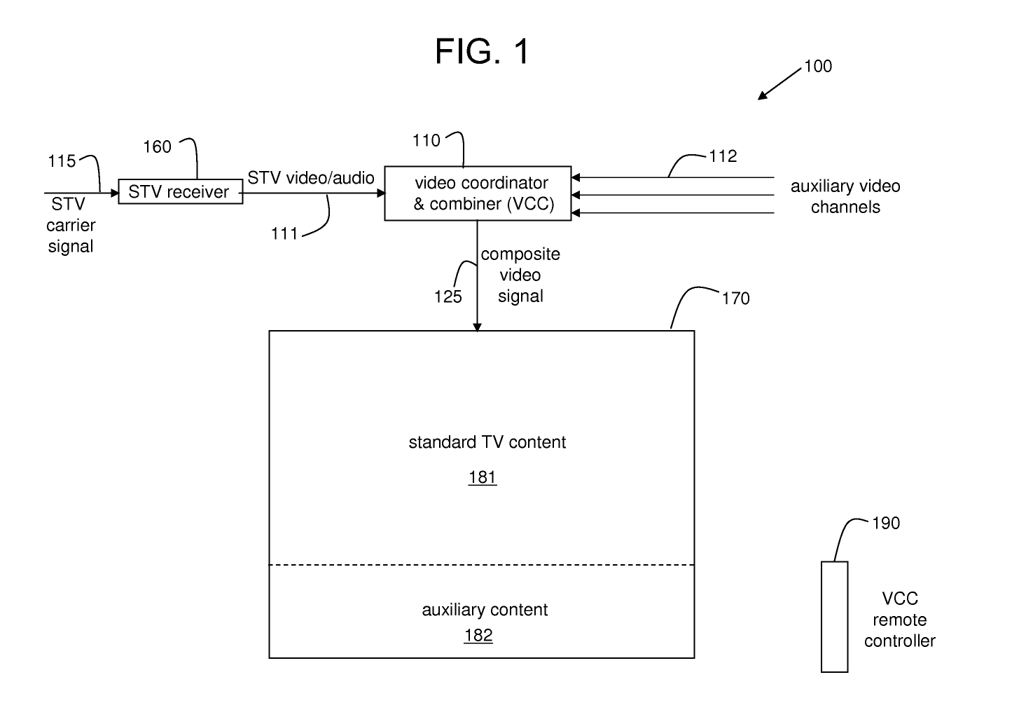

FIG. 1 illustrates a schematic block diagram of a system 100 having a first embodiment of a video coordinator and combiner (VCC) apparatus 110 for generating coordinated video content for display, and showing a first example embodiment of a coordinated video display partition or format. In the system 100, the VCC 110 receives a standard television (STV) video signal 111 (along with audio) from a STV receiver 160 which converts a STV carrier signal 115 into the STV video signal 111. The STV carrier signal 115 may be from a first source such as a cable TV source, a satellite TV source, or an over-the-air broadcast TV source, for example. Similarly, the VCC 110 receives at least one auxiliary video signal 112 from at least one auxiliary video source (i.e., a second source such as, for example, a personal computer) over an auxiliary video channel. As such, the second source is independent of the first source. The VCC 110 is operatively connected to a video display 170 (e.g., a television set having a television screen or a video monitor) which receives a single composite video signal 125 from the VCC 110. The composite video signal 125 is a combination of a portion of the STV video signal 111 and a portion of the auxiliary video signal 112. FIG. 1 shows an example of where, on the video display 170, the standard TV content 181 from the portion of the STV video signal 111 is displayed and where the auxiliary content 182 from the portion of the auxiliary video signal 112 is displayed (i.e., a partition of video display real estate between standard TV content and auxiliary content).

For example, as shown in FIG. 1, the standard TV content 181 may be from a television comedy show broadcast on a particular television channel, and the auxiliary content 182 may be from a sports web page on the internet, via a personal computer (PC) and web browser, showing various updated sports scores. As shown in FIG. 1, the standard TV content 181 uses most of the video display 170, and the auxiliary content 182 uses a lesser lower portion of the video display 170. As a result, a user, having a personal computer (PC) operatively connected to the VCC 110 may easily keep up with current sports scores (e.g., football scores) while watching the comedy show.

As is described in detail later herein, the portion of the STV video signal 111 corresponding to a desired portion of the STV video content 181, and the portion of the auxiliary video signal 112 corresponding to a desired portion of the auxiliary video content 182 are selectable by a user using a VCC remote controller 190 which interacts with the VCC 110. The VCC remote controller 190 is also used to select where on the video display 170 the video content will appear.

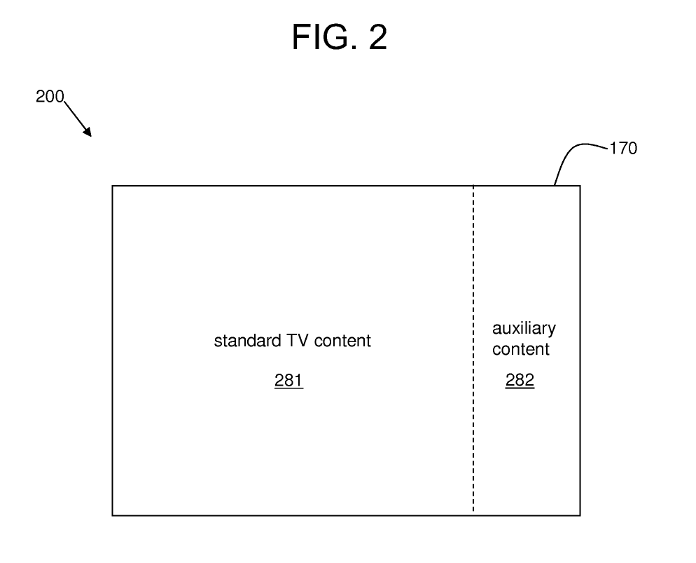

The partition of video display real estate between standard TV content and auxiliary content shown in FIG. 1 is just one possible example. FIG. 2 illustrates a second example embodiment of a coordinated video display partition or format 200. In FIG. 2, the standard TV content 281 is shown to the left of the auxiliary content 282 on the video display 170. The standard TV content 281 uses most of the video display 170 and the auxiliary content 282 uses a lesser right hand portion of the video display 170, as shown in FIG. 2. For example, the standard TV content 281 may be from a television news broadcast on a particular television channel, and the auxiliary content 282 may be from a software application running on a personal computer (PC) showing a calendar with various task due dates.

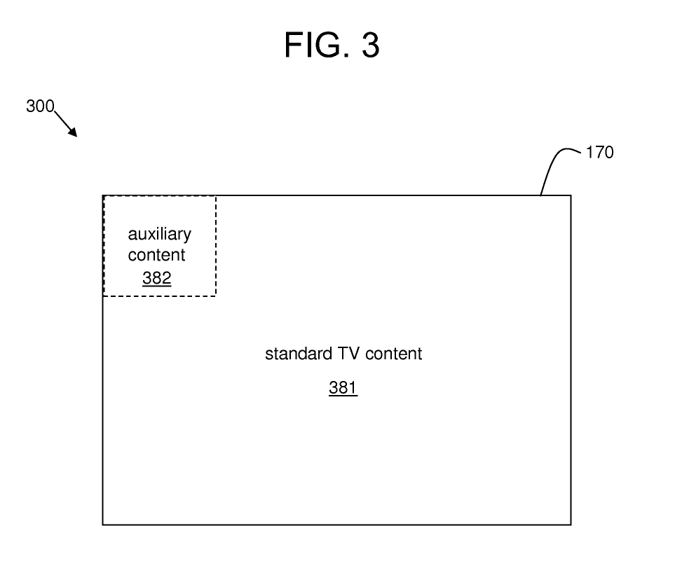

FIG. 3 illustrates a third example embodiment of a coordinated video display partition or format 300. In FIG. 3, the auxiliary content 382 is shown occupying an upper left region of the video display 170 and the standard TV content 381 occupies the rest of the video display 170. The standard TV content 381 uses most of the video display 170 and the auxiliary content 282 uses a lesser upper left portion of the video display 170, as shown in FIG. 3. For example, the standard TV content 381 may be from a television game show broadcast on a particular television channel, and the auxiliary content 382 may be from a financial web page on the internet, via a personal computer (PC) and web browser, showing a stock chart in near real time.

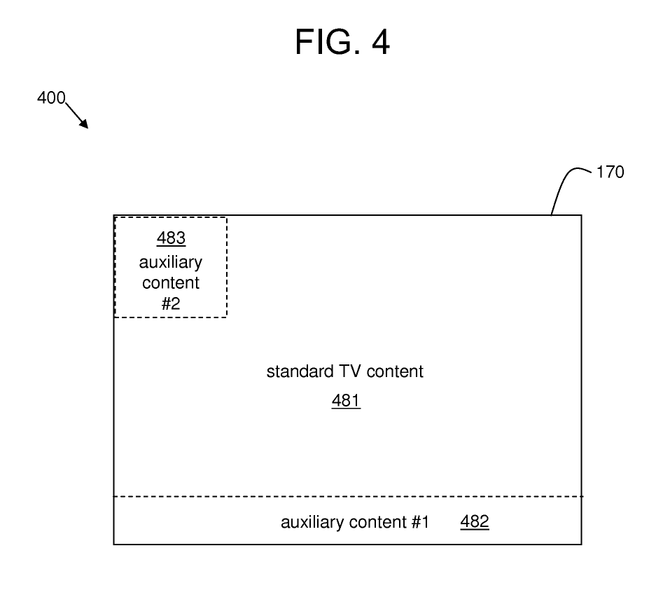

FIG. 4 illustrates a fourth example embodiment of a coordinated video display partition or format 400. In FIG. 4, two auxiliary contents are shown instead of just one. The auxiliary content #2, 483, is shown occupying an upper left region of the video display 170. The auxiliary content #1, 482, is shown occupying a lower region of the video display 170. The standard TV content 481 occupies the remaining portion of the video display 170. The standard TV content 481 uses most of the video display 170 whereas and the auxiliary content 483 uses a lesser upper left portion of the video display 170 and the auxiliary content 482 uses a lesser lower portion of the video display 170, as shown in FIG. 4. For example, the standard TV content 481 may be from a movie on a DVD, the auxiliary content 482 may be from a financial web page on the internet, via a personal computer (PC) and web browser, showing stock prices in near real time running across the bottom of the screen 170, and the auxiliary content 483 may be from a software application running on a personal computer (PC) showing an email inbox folder. As such, all three sources of video content are independent of each other. This is different from a picture-in-picture (PIP) implementation where, for example, a first video content and a second video content are from the same source (e.g., a television receiver).

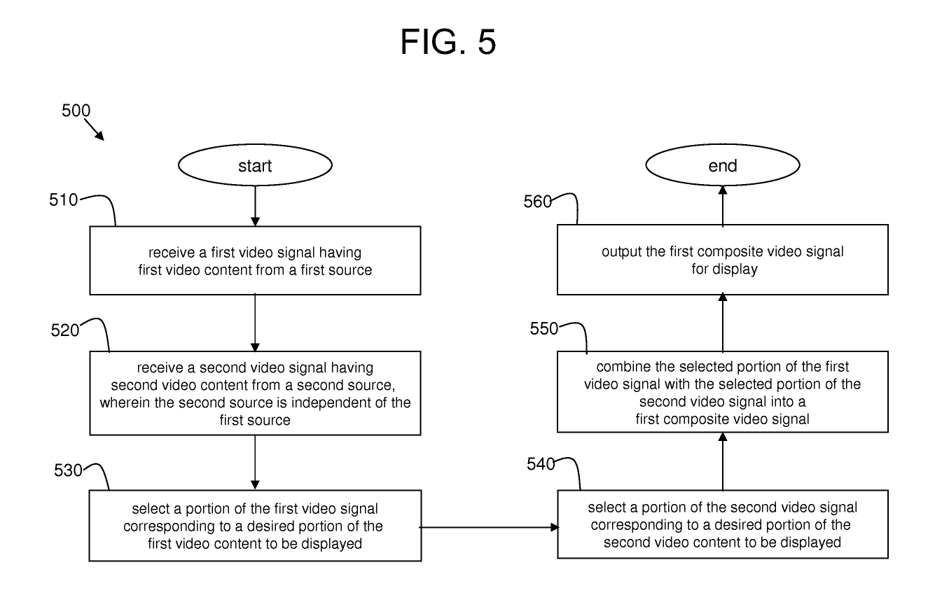

FIG. 5 is a flowchart of a first embodiment of a method 500 for generating coordinated video content for display using the VCC 110 of FIG. 1. In step 510, receive a first video signal (e.g., 111) having first video content (e.g., a broadcast television show) from a first source. In step 520, receive a second video signal (e.g., 112) having second video content (e.g., an internet web page) from a second source, wherein the second source is independent of the first source (i.e., the first video content and the second video content are from two different sources such as, for example, a STV receiver 160 and a PC).

In step 530, select a portion of the first video signal corresponding to a desired portion of the first video content to be displayed (e.g., 181). In step 540, select a portion of the second video signal corresponding to a desired portion of the second video content to be displayed (e.g., 182). Again, selecting the portion of the first video signal corresponding to a desired portion of the first video content, and selecting the portion of the second or auxiliary video signal corresponding to a desired portion of the second video content are described in detail later herein in the context of a user using a VCC remote controller 190 which interacts with the VCC 110. The VCC remote controller 190 is also used to select where on the video display 170 the video content will appear.

In step 550, combine the selected portion of the first video signal with the selected portion of the second video signal into a first composite video signal (e.g., 125). The composite video signal is a single video signal having encoded thereon the selected portion of the first video content and the selected portion of the second video content. In accordance with an embodiment of the present invention, the selected portions of the video contents are encoded into the composite video signal such that displayed frames of the composite video signal position the video contents in the desired selected locations on the video display 170 (e.g., in left/right relation as shown in FIG. 2, or in up/down relation as shown in FIG. 1). In step 560, output the first composite video signal (e.g., 125) for display (e.g., to the video display 170).

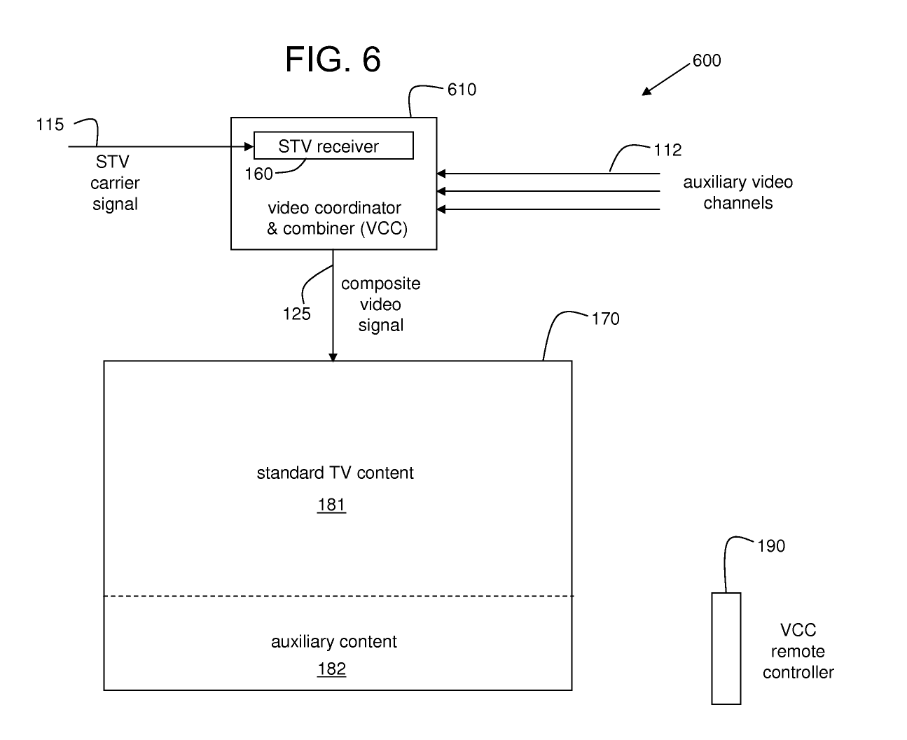

Other system configurations having a VCC, other than that of FIG. 1, are possible as well in accordance with various embodiments of the present invention. For example, FIG. 6 illustrates a schematic block diagram of a system 600 having a second embodiment of a video coordinator and combiner (VCC) apparatus 610 for generating coordinated video content for display. The system 600 is very similar to the system 100 of FIG. 1 except that, in this embodiment, the functionality of the STV receiver 160 is integrated into the VCC 610. Therefore, the STV carrier signal 115 is directly received by the VCC 610 and the STV video signal 111 is generated within the VCC 610 by the STV receiver 160.

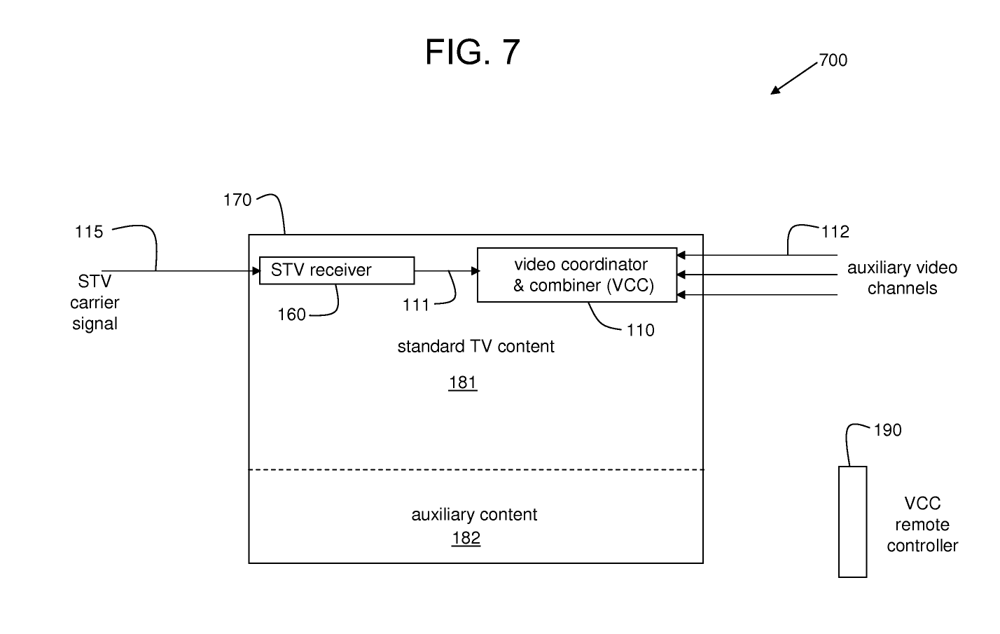

FIG. 7 illustrates a schematic block diagram of a system 700 having a third embodiment of a video coordinator and combiner (VCC) apparatus 110 for generating coordinated video content for display. The system 700 is somewhat similar to the system 100 of FIG. 1 and the system 600 of FIG. 6 except that, in this embodiment, the functionality of the STV receiver 160 and the VCC 110 are integrated into the television set 170. Therefore, the STV carrier signal 115 and the auxiliary video signal 112 are directly received by the television set 170. The STV video signal 111 and the composite video signal 125 are generated by the STV receiver 160 and the VCC 110, respectively, within the television set 170.

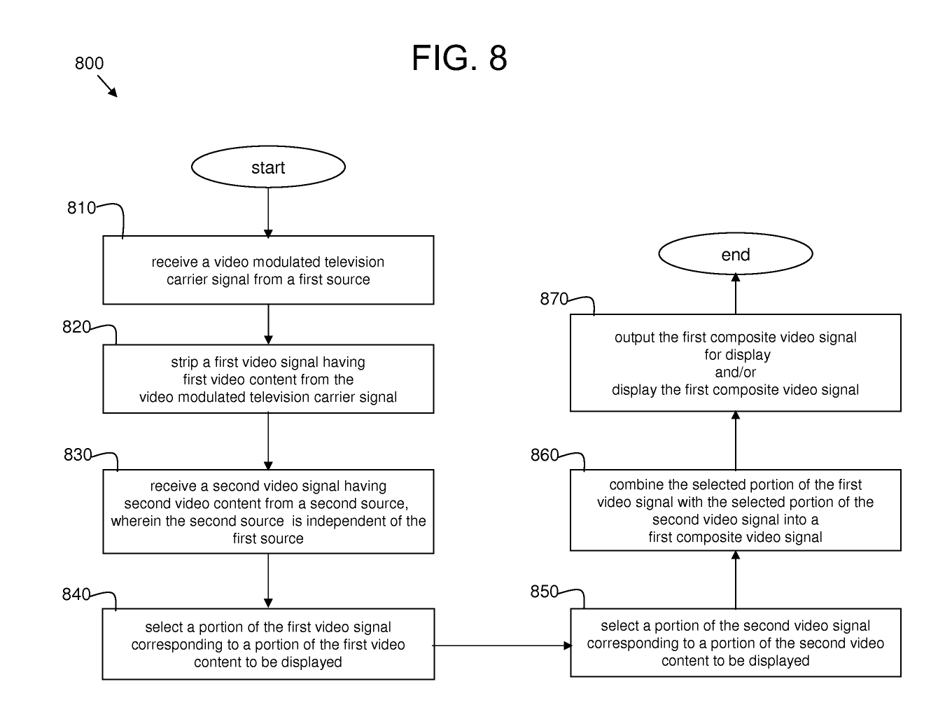

FIG. 8 is a flowchart of a second embodiment of a method 800 for generating coordinated video content for display using, for example, the system of FIG. 6 or the system of FIG. 7. In step 810, receive a video modulated television carrier signal (e.g., 115) from a first source. In step 820, strip a first video signal (e.g., 111) having first video content from the video modulated television carrier signal. In step 830, receive a second video signal (e.g., 112) having second video content from a second source, wherein the second source is independent of the first source.

In step 840, select a portion of the first video signal corresponding to a portion of the first video content to be displayed (e.g., 181). In step 850, select a portion of the second video signal corresponding to a portion of the second video content to be displayed (e.g., 182). Again, selecting the portion of the first video signal corresponding to a desired portion of the first video content, and selecting the portion of the second or auxiliary video signal corresponding to a desired portion of the second video content are described in detail later herein in the context of a user using a VCC remote controller 190 which interacts with the VCC 110. The VCC remote controller 190 is also used to select where on the video display 170 the video content will appear.

In step 860, combine the selected portion of the first video signal with the selected portion of the second video signal into a first composite video signal (e.g., 125). In step 870, output the first composite video signal for display and/or display the first composite video signal.

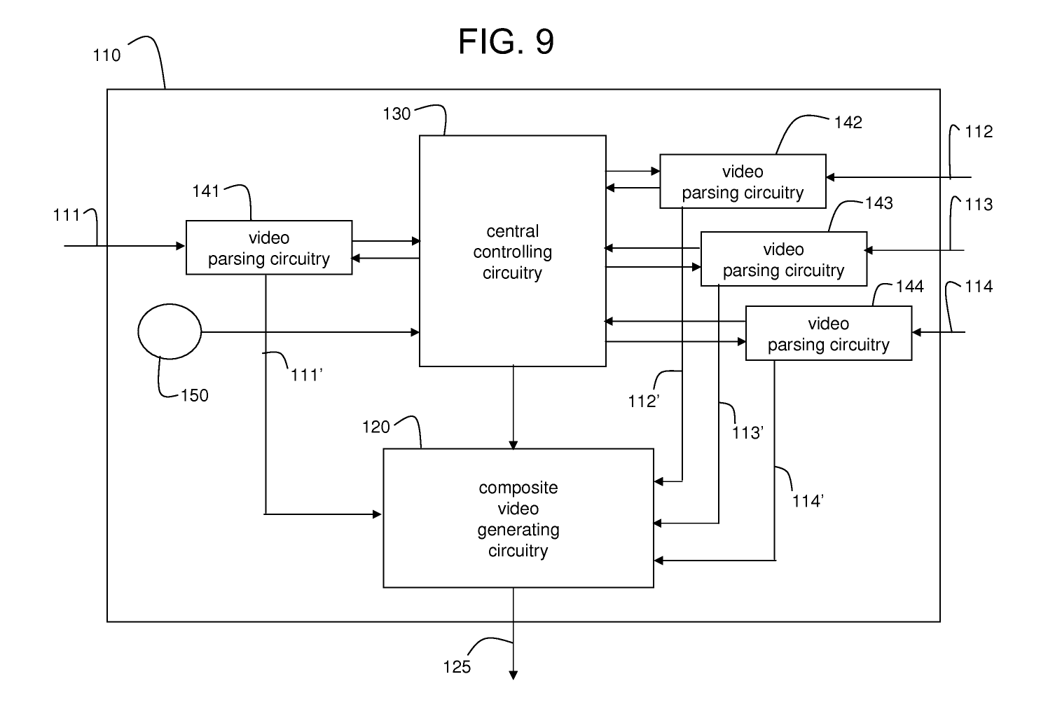

FIG. 9 illustrates a schematic block diagram of an embodiment of the VCC 110 of FIG. 1. The VCC 110 includes composite video generating circuitry 120 operatively connected to central controlling circuitry 130. The VCC 110 further includes a plurality of video parsing circuitry 141-144 operatively connected to the composite video generating circuitry 120 and the central controlling circuitry 130. The VCC 110 also includes a remote command sensor 150 operatively connected to the central controlling circuitry 130. The central controlling circuitry 130, video parsing circuitry 141-144, and composite video generating circuitry 120 include various types of digital and/or analog electronic chips and components which are well known in the art, and which are combined and programmed in a particular manner for performing the various functions described herein. Furthermore, the particular design of the video parsing circuitry 141-144, the composite video generating circuitry 120, and the central controlling circuitry 130 may depend on the type of video to be processed (e.g., analog video or digital video) and the particular video format (e.g., RS-170, CCIR, RS-422, or LVDS). However, in accordance with a particular embodiment of the present invention, the video parsing circuitry, the composite video generating circuitry, and the central controlling circuitry are designed to accommodate a plurality of analog and digital video formats.

The remote command sensor 150 is capable of wirelessly (or via wired means) receiving commands (e.g., via electrical, optical, infrared, or radio frequency means) from the VCC remote controller 190 as operated by a user, and passing those commands on to the central controlling circuitry 130. The technologies for configuring such a remote command sensor 150 and controller 190 are well known in the art. The central controlling circuitry 130 is the main controller and processor of the VCC 110 and, in accordance with an embodiment of the present invention, includes a programmable microprocessor and associated circuitry for operatively interacting with the video parsing circuitry 141-144, the composite video generating circuitry 120, and the remote command sensor 150 for receiving commands, processing commands, and outputting commands.

The video parsing circuitry 141-144 each are capable of receiving an external video signal (e.g., 111-114), extracting a selected portion of video content from the video signal (i.e., parsing the video signal) according to commands from the central controlling circuitry 130, and passing the extracted (parsed) video content (e.g., 111′-114′) on to the composite video generating circuitry 120. In accordance with an embodiment of the present invention, the video parsing circuitry 141-144 includes sample and hold circuitry, analog-to-digital conversion circuitry, and a programmable video processor. The composite video generating circuitry 120 is capable of accepting the parsed video content (e.g., 111′-114′) from the video parsing circuitry 141-144 and combining the parsed signals into a single composite video signal 125 according to commands received from the central controlling circuitry 130. In accordance with an embodiment of the present invention, the composite video generating circuitry 120 includes a programmable video processor and digital-to-analog conversion circuitry.

In accordance with an embodiment of the present invention, parsing a video signal involves extracting video content from a same portion of successive video frames from a video signal. A frame of a video signal typically includes multiple horizontal lines of video data or content and one or more fields (e.g., interlaced video) along with sync signals (for analog video) or clock and enable signals (for digital video). The portion of the video frames to be extracted is selected by a user using the VCC remote controller 190 while viewing the full video content (i.e., full video frames) on the video display 170.

As an example, referring to FIG. 1, a user sends a video channel select command from the VCC remote controller 190 to the VCC 110 to display an auxiliary video signal 112 (e.g., from a PC) having auxiliary video content on the video display 170. Referring to FIG. 9, the command from the controller 190 is received by the sensor 150 of the VCC 110 and is sent to the central controlling circuitry 130. The central controlling circuitry 130 processes the command and directs the video parsing circuitry 142 to pass the entire (unparsed) video content of the video signal 112 to the composite video generating circuitry. The central controlling circuitry 130 also directs the composite video generating circuitry 120 to output the entire (unparsed) video content of the video signal 112 in the composite video signal 125. Therefore, the full auxiliary video content of the video signal 112 is displayed on the video display 170 via the composite video signal 125.

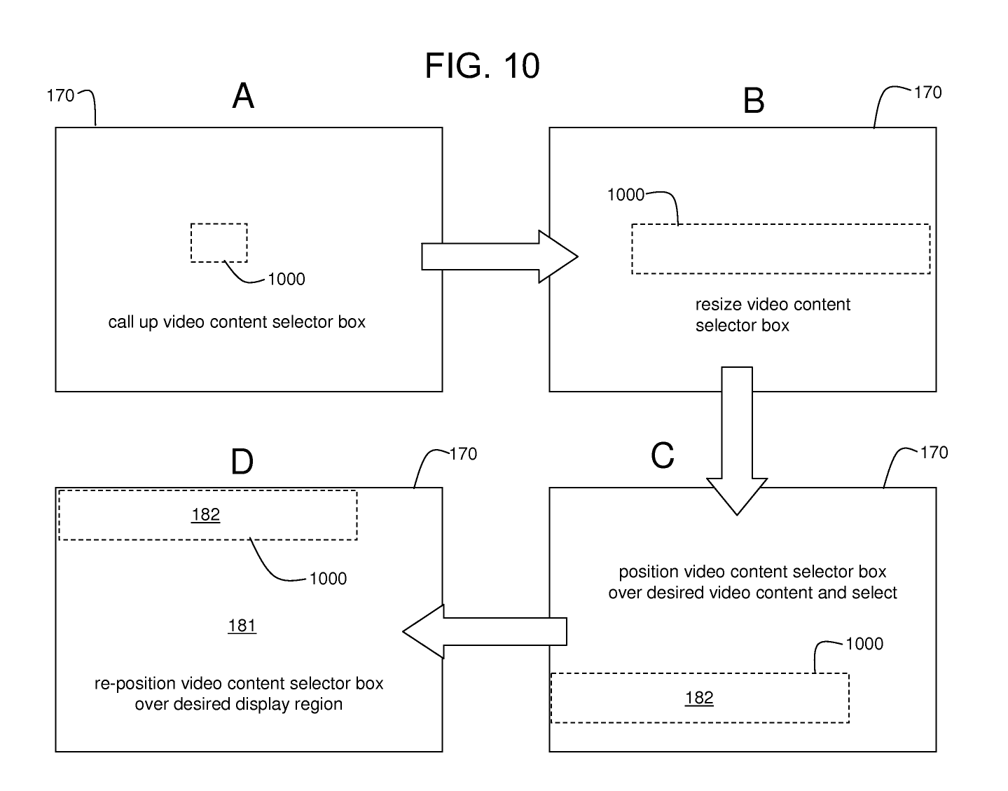

Next, referring to FIG. 10, the user sends a video content select command from the VCC remote controller 190 to the VCC 110 to call up and display a video content selector box 1000 on the video display 170, inserted in the displayed auxiliary video content (see FIG. 10A). Referring again to FIG. 9, the command from the controller 190 is received by the sensor 150 of the VCC 110 and is sent to the central controlling circuitry 130. The central controlling circuitry 130 processes the command and directs the composite video generating circuitry 120 to insert the video content selector box 1000 into the composite video signal 125 such that the video content selector box 1000 is displayed on the video display 170 overlaid on the full auxiliary video content in the composite video signal 125. Just the outline or border of the box 1000 is displayed and the portion of the auxiliary video content encapsulated or surrounded by the border of the box 1000 can be seen within the box 1000.

Continuing with the example, the user manipulates the controls on the remote controller 190 to re-size the video content selector box 1000 to a desired size (see FIG. 10B). As such, referring again to FIG. 9, commands from the controller 190 are received by the sensor 150 of the VCC 110 and are sent to the central controlling circuitry 130. The central controlling circuitry 130 processes the commands and directs the composite video generating circuitry 120 to re-size the video content selector box 1000 within the composite video signal 125 according to the commands. The user is able to easily see the result of the re-sizing on the video display 170 (see FIG. 10B). Again, the portion of the auxiliary video content surrounded by the border of the box 1000 can be seen within the box 1000.

The user then manipulates the controls on the remote controller 190 to position the video content selector box 1000 over the desired portion of the displayed auxiliary video content to be selected (see FIG. 10C). Referring to FIG. 9, commands from the controller 190 are received by the sensor 150 of the VCC 110 and are sent to the central controlling circuitry 130. The central controlling circuitry 130 processes the commands and directs the composite video generating circuitry 120 to re-position the video content selector box 1000 within the composite video signal 125 according to the commands. The user is able to easily see the positioned box 1000 on the video display 170 (see FIG. 10C) surrounding the desired portion of the auxiliary video content (frame) to be selected and parsed.

The user then sends a video content portion set command, using the controller 190, to the VCC 110 telling the VCC 110 to lock in or select the video content portion within the box 1000. The selected video content portion 182 of the auxiliary video content is displayed within the box 1000, and the STV video content 181 is displayed on the remaining portion of the video display 170 not occupied by the box 1000. Referring to FIG. 9, the video content portion set command from the controller 190 is received by the sensor 150 of the VCC 110 and is sent to the central controlling circuitry 130. The central controlling circuitry 130 processes the command and directs the video parsing circuitry 141 to parse the STV video signal 111 to extract all of the video content from the frames of the STV video signal 111 except that portion corresponding to the current position of the box 1000 on the video display 170. Similarly, the central controlling circuitry 130 also directs the video parsing circuitry 142 to parse the auxiliary video signal 112 to extract the selected video content portion, corresponding to the box 1000, from the frames of the auxiliary video signal 112.

The central controlling circuitry 130 further directs the video parsing circuitry 141 and the video parsing circuitry 142 to send the parsed STV content data 111′ and the parsed auxiliary content data 112′, respectively, to the composite video generating circuitry 120. The composite video generating circuitry 120 generates a composite video signal 125 which includes the combined video content from the parsed STV content data 111′ and the parsed auxiliary content data 112′, based on the current position of the box 1000 on the video display 170 as provided by the central controlling circuitry 130.

When parsing a video signal, the video parsing circuitry uses the selector box information provided by the central controlling circuitry 130 to determine which portions of which successive horizontal lines of video frames are to be extracted from the video signal. The corresponding portion of the video signal is sampled and extracted and sent to the composite video generating circuitry 120, for each frame (and/or field) of video, as parsed content data. The term “parsed content data” as used herein refers to sampled digital or analog video signal data that is sent to the composite video generating circuitry to be re-formatted as a true composite video signal.

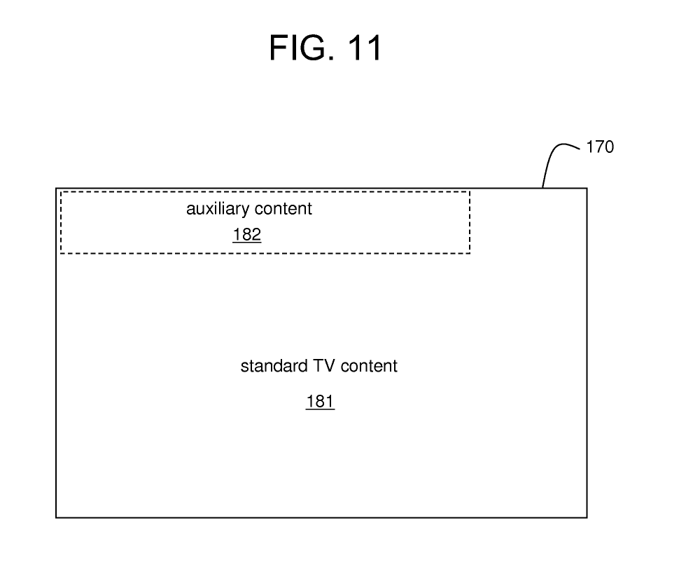

The user may then manipulate the controls on the remote controller 190 to re-position the video content selector box 1000 over a desired auxiliary display region (e.g., upper left) on the video display 170 (see FIG. 10D). Referring to FIG. 9, the re-positioning commands from the controller 190 are received by the sensor 150 of the VCC 110 and are sent to the central controlling circuitry 130. The central controlling circuitry 130 processes the commands and directs the composite video generating circuitry 120 to re-position the video content selector box 1000 within the composite video signal 125 according to the commands. The user is able to easily see the re-positioned box 1000 on the video display 170 having the selected auxiliary video content portion 182, and the remaining portion of the video display 170 having the STV video content portion 181 as shown in FIG. 11. In accordance with an embodiment of the present invention, audio from the standard television signal is passed through to the television set 170.

As discussed above with respect to FIG. 4, additional auxiliary video signals from other independent auxiliary video sources may be received by the VCC 110 and content portions thereof incorporated into the composite video signal 125 in accordance with the methods described herein. In general, a user of the VCC 110 has the ability to select any combination of available video channels, and content portions thereof, to be incorporated into the composite video signal 125. Independent auxiliary video sources may include, for example, a personal computer (PC), a digital video recorder (DVR), a VCR player, another television receiver, and a DVD player. Other independent auxiliary video sources are possible as well.

In accordance with an alternative embodiment of the present invention, pre-defined video content selector boxes having pre-defined sizes and display positions may be provided in the VCC. For example, instead of having to manually re-size and re-position the video content selector box, when a user uses the VCC remote controller to send a video content select command from the VCC remote controller 190 to the VCC 110 to call up and display a video content selector box 1000 on the video display 170, the video content selector box 1000 may instead automatically appear on the display 170 at the desired size and over the desired portion of the displayed auxiliary video content.

In such an alternative embodiment, the central controlling circuitry 130 knows which video source the auxiliary video is derived from (e.g., due to communication with the video parsing circuitry) and selects an appropriately matched pre-defined box 1000 based on the known auxiliary video source. The pre-defined video content selector boxes may each be initially pre-defined and matched to a particular video source by a user. Then subsequently, whenever, the user selects a particular auxiliary video source to be combined with, for example, video from a STV video source, the corresponding pre-defined video content selector box is automatically incorporated into the composite video signal 125 and displayed at the proper location over the auxiliary video content. Such an embodiment saves the user several steps using the controller 190.

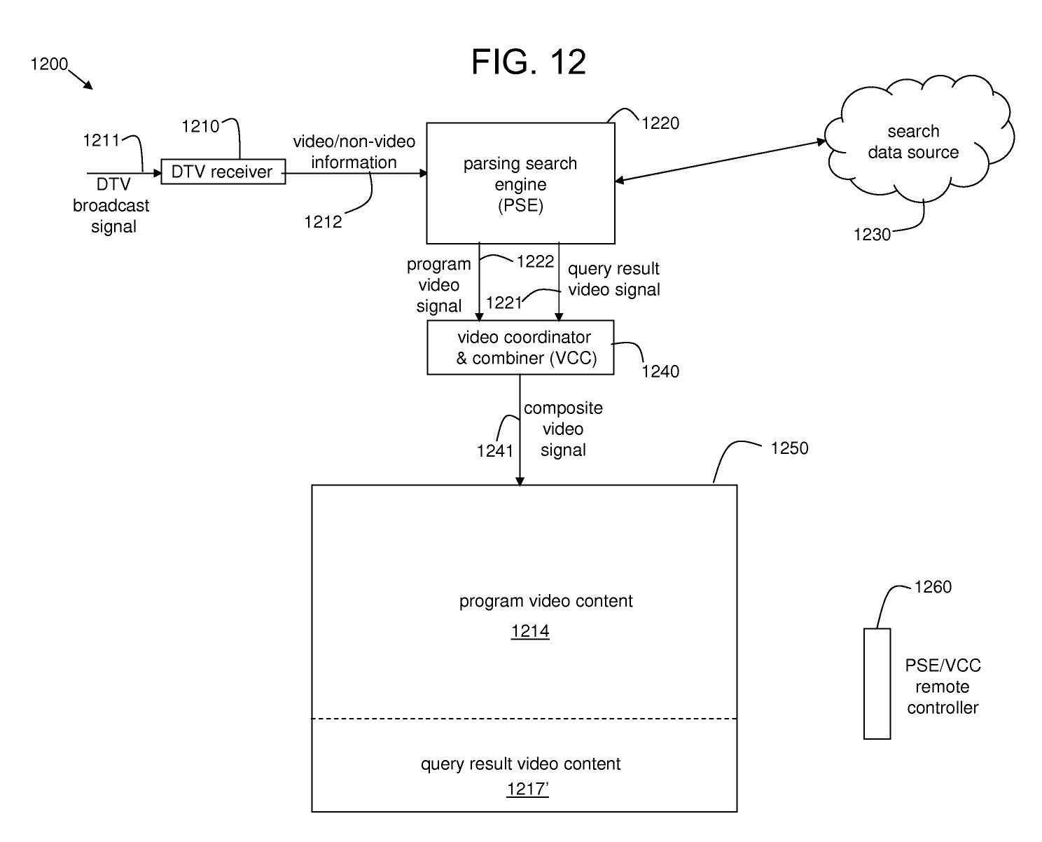

FIG. 12 illustrates a schematic block diagram of a first embodiment of a system 1200 for acquiring search content based on digital information content provided from a video source. The system includes a digital television (DTV) receiver 1210 (i.e., a video source) capable of receiving a DTV broadcast signal 1211. As used herein, the term DTV receiver 1210 includes, for example, any of a digital terrestrial television receiver (using an antenna), a digital cable television receiver, a digital satellite television receiver, a digital microwave television receiver, and an internet protocol television receiver as are well known in the art. Furthermore, as used herein, the term DTV broadcast signal 1211 includes any television signal that is modulated with video information and associated non-video information 1212 (a.k.a., video/non-video information). The DTV receiver 1210 is capable of decoding or demodulating the DTV broadcast signal 1211 to extract the video/non-video information 1212.

In accordance with an embodiment of the present invention, the video/non-video information 1212 is at least one digital video data channel having a digital video sub-channel encoded with digital video content, an associated digital audio sub-channel encoded with digital audio content, and an associated digital information sub-channel encoded with digital information content. Alternatively, in accordance with another embodiment of the present invention, the video/non-video information 1212 is already decoded into the component parts of digital video content, digital audio content, and digital information content. The exact nature of the video/non-video information 1212 depends on the particular embodiment and operation of the DTV receiver 1210.

The system 1200 further includes a parsing search engine (PSE) 1220 operatively interfacing to the DTV receiver 1210. The PSE 1220 is capable of receiving the video/non-video information 1212 from the DTV receiver 1210. The system 1200 also includes a search data source 1230 operatively interfacing to the PSE 1220. The search data source 1230 may include, for example, the internet or some other global network having various servers, search engines, and web sites which are well known. The system further includes a video coordinator and combiner (VCC) 1240 operatively interfacing to the PSE 1220. The VCC 1240 is of the type previously described herein with respect to FIGS. 1-11. The system 1200 also includes a video display device 1250 operatively interfacing to the VCC 1240. The system further includes a remote controller 1260 capable of being used to control the functionality of at least one of the DTV receiver 1210, the PSE 1220, and the VCC 1240.

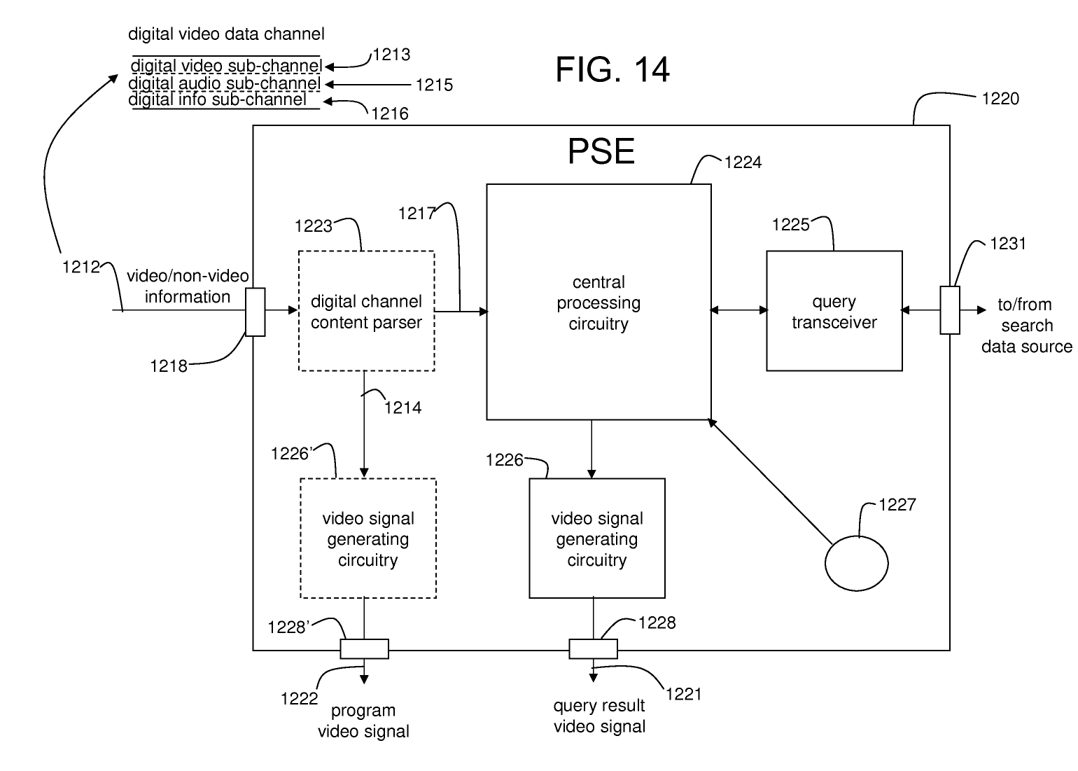

Referring to FIG. 14, the video/non-video information 1212 may include a digital video data channel having a digital video sub-channel 1213 encoded with digital program video content 1214 of a sporting event, an associated digital audio sub-channel 1215 encoded with digital audio content corresponding to the sporting event, and an associated digital information sub-channel 1216 encoded with digital information content 1217 corresponding to the sporting event. The encoded digital information content 1217 may include, for example, the name of the sports league associated with the sporting event (e.g., the national football league), the names of the sports teams that are playing each other in the sporting event (e.g., New Orleans Saints v. Indianapolis Colts), and the name of the broadcast network broadcasting the sporting event (e.g., CBS). Other types of digital information content are possible as well.

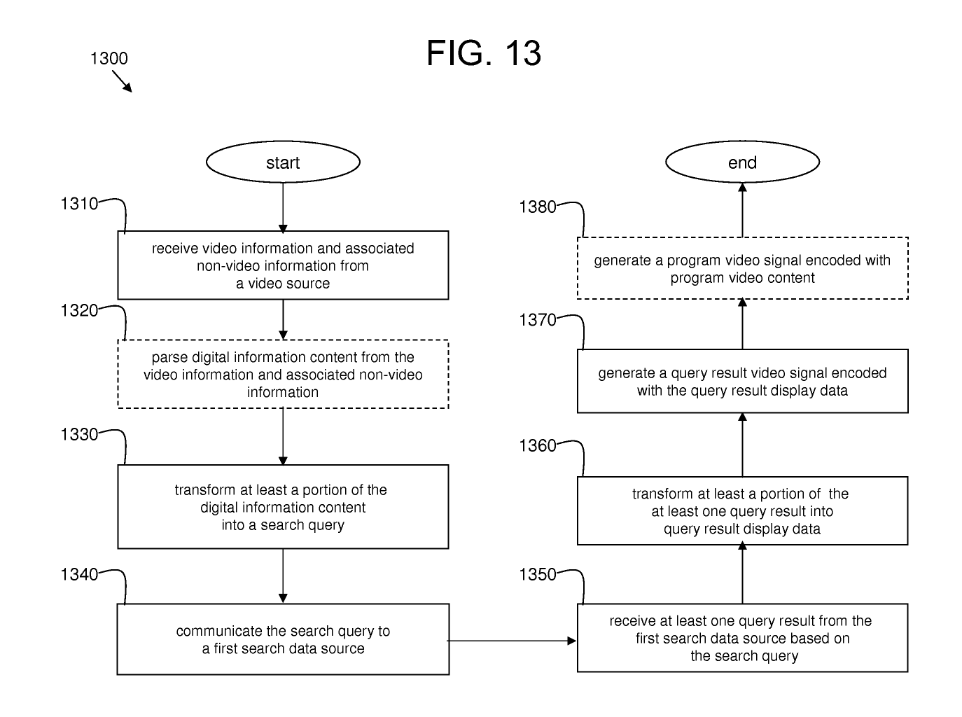

FIG. 13 is a flowchart of an embodiment of a method 1300 for acquiring search content based on digital information content 1217 (e.g., digital information content 1217 encoded in a sub-channel 1216 of a digital video data channel 1212) provided from a video source 1210 using the PSE 1220 of the system 1200 of FIG. 12. In step 1310, the PSE 1220 receives video information and associated non-video information 1212 from a video source 1210. Again, the video information includes program video content 1214 and the non-video information includes digital information content 1217 and program audio content. In step 1320, the PSE 1220 parses the digital information content 1217 from the video/non-video information 1212. Step 1320 is an optional step in that step 1320 is not performed if the video/non-video information 1212 is already decoded into the component parts of digital video content, digital audio content, and digital information content. In step 1330, the PSE 1220 transforms at least a portion of the digital information content 1217 into a search query. In step 1340, the PSE 1220 communicates the search query to a first search data source 1230. In step 1350, the PSE 1220 receives at least one query result from the first search data source 1230 based on the search query. In step 1360, the PSE 1220 transforms at least a portion of the at least one query result into query result display data. In step 1370, the PSE 1220 generates a query result video signal 1221 encoded with the query result display data. As an option, in step 1380, the PSE 1220 generates a program video signal 1222 encoded with the program video content 1214.

The query result video signal 1221 and the program video signal 1222 may each be output from the PSE 1220. In accordance with various embodiments of the present invention, the program video signal 1222 may be the original digital video data channel 1212 or may be a new video signal derived from the original digital video data channel 1212, as is described in more detail herein with respect to FIG. 14. Referring again to the embodiment of FIG. 12, the program video signal 1222 and the query result video signal 1221 are combined by the VCC 1240 into a single composite video signal 1241. The composite video signal is sent to the video display device 1250 where the program video content 1214 and query result video content 1217′, which is derived indirectly from the digital information content 1217 via a search as described later in more detail herein with respect to FIGS. 12-14, may be displayed in accordance with the methods described previously herein with respect to FIGS. 1-11.

As an example, a user may be using the system 1200 of FIG. 12 to view a sporting event (e.g., a live broadcast of a football game). The digital information content 1217 broadcast along with the program video and audio content of the sporting event includes the names of the two teams currently playing against each other in the sporting event (e.g., the Cleveland Browns and the Pittsburgh Steelers) and the date of the sporting event (e.g., the current date of Dec. 10, 2009). As a result, the PSE 1220 parses the digital information content 1217 (team names and date) from the video/non-video information 1212 and automatically generates a search query based on the team names and date. The resultant search query is “Cleveland Browns injury report”. This search query is communicated from the PSE 1220 to the first search data source 1230 (e.g., communicated to Google via the internet).

The first search data source 1230 performs a search based on the search query and returns a query result to the PSE 1220. The query result is a list of injured players for the Cleveland Browns along with the associated injury of each injured player. The PSE 1220 grabs only the names of the injured players to form query result display data from the query result. The PSE then generates a query result video signal 1221 having the names of the injured players as the query result video content 1217′. The PSE 1220 also generates a program video signal 1222 (which includes the program video content 1214 and program audio content of the sporting event) from the received video/non-video information 1212.

The VCC 1240 combines the program video signal 1222 and the query result video signal 1221 into a composite video signal 1241, according to the methods and techniques described herein with respect to FIGS. 1-11, and outputs the composite video signal to the display 1250. As a result, the query result video content 1217′ (i.e., the names of the injured Cleveland Browns players) are scrolled across the bottom of the display 1250 and the program video content 1214 is displayed on the majority of the display 1250.

FIG. 14 illustrates a schematic block diagram of an embodiment of a parsing search engine 1220 used in the system 1200 of FIG. 12. The PSE 1220 includes at least one input port 1218 for accepting the video/non-video information 1212 from the video source 1210. The PSE 1220 also include a digital channel content parser 1223 for receiving the video/non-video information 1212 (e.g., as a digital video data channel having video, audio, and digital information sub-channels) via the input port 1218 and parsing (separating, extracting) the digital information content 1217 from the video/non-video information 1212. The parsed digital information content 1217 is then passed to the central processing circuitry 1224 of the PSE 1220. In accordance with an embodiment of the present invention, the digital channel content parser 1223 includes digital decoding chips and other logic circuitry which are well known in the art. The digital channel content parser 1223 is shown in dotted line in FIG. 14 as being optional to indicate that the parser 1223 may not be used if the video/non-video information 1212 from the video source 1210 is already decoded into the component parts of digital video content 1214, digital audio content, and digital information content 1217. In such a case, the digital information content 1217 is passed directly from the input port 1218 to the central processing circuitry 1224.

The central processing circuitry 1224 receives the digital information content 1217 and proceeds to transform at least a portion of the digital information content 1217 into a search query. In accordance with an embodiment of the present invention, the central processing circuitry 1224 includes a microprocessor and is software programmed to automatically generate the search query in a particular manner based on the digital information content 1217. For example, the central processing circuitry 1224 may be programmed to recognize, from the digital information content 1217, if the video/non-video information 1212 corresponds to a live sporting event and, if so, to generate a search query that will allow injured players and team win/loss records to be searched for. In accordance with another embodiment of the present invention, a user is able to use the remote control device 1260 to interact with the PSE 1220, via the display 1250 and the sensor 1227, to view menu selections that allow a user to select or set up how the search query is to be generated based on the digital information content 1217. For example, if the digital information content 1217 indicates that the video/non-video information 1212 corresponds to a national news program, the user may be able to set up the PSE 1220 to generate a search query to retrieve the latest national news headlines. Similarly, if the digital information content 1217 indicates that the video/non-video information 1212 corresponds to a weather program, the user may be able to set up the PSE 1220 generate a search query to retrieve the local temperature, humidity, and weather forecast. In this manner, the central processing circuitry 1224 functions as an automated web browser. The remote command sensor 1227 is operatively connected to the central processing circuitry 1224 and is capable of wirelessly (or via wired means) receiving commands (e.g., via electrical, optical, infrared, or radio frequency means) from the remote controller 1260 as operated by a user, and passing those commands on to the central processing circuitry 1224. The technologies for configuring such a remote command sensor 1227 and controller 1260 are well known in the art.

Once a search query is generated, the search query is passed to a query transceiver 1225 of the PSE 1220. The query transceiver 1225 may be a wired or wireless transceiver that is capable of accessing a global information network such as, for example, the internet via a network port 1231, and sending the search query to a search data source 1230. In accordance with an embodiment of the present invention, the query transceiver 1225 is a cable modem, which is well known in the art. The query transceiver 1225 is further capable of receiving back query results from the search data source 1230 via the network port 1231 and passing the query results back to the central processing circuitry 1224. The query results may include a plurality of information, some of which is desired and some of which is not desired. The central processing circuitry 1224 analyzes the query results and pulls out or extracts the desired information as query result display data, based on pre-programmed preferences or user-selected preferences.

The query result display data is then passed to video signal generating circuitry 1226 of the PSE 1220. The video signal generating circuitry 1226 receives the query result display data and encodes the query result display data into a query result video signal 1221 which may be output for display via output display port 1228. The video signal generating circuitry 1226 includes video encoding chips and logic circuitry which are well known in the art, in accordance with an embodiment of the present invention.

The digital channel content parser 1223 is further capable of extracting the program video content 1214 and audio content from the video/non-video information 1212 and passing the program video content 1214 and audio content to another video signal generating circuitry 1226′, similar to the video signal generating circuitry 1226. The video signal generating circuitry 1226′ receives the video content 1214 and audio content from the digital channel content parser 1223 and encodes the program video content 1214 and associated audio content into a program video signal 1222 which may be output for display via output display port 1228′. In accordance with another embodiment of the present invention, the video signal generating circuitry 1226′ may not be used and, therefore, is represented as being optional in the case where the video/non-video information 1212 (e.g., in the form of an encoded digital video data channel) is simply passed directly from the digital channel content parser 1223 to the output display port 1228′.

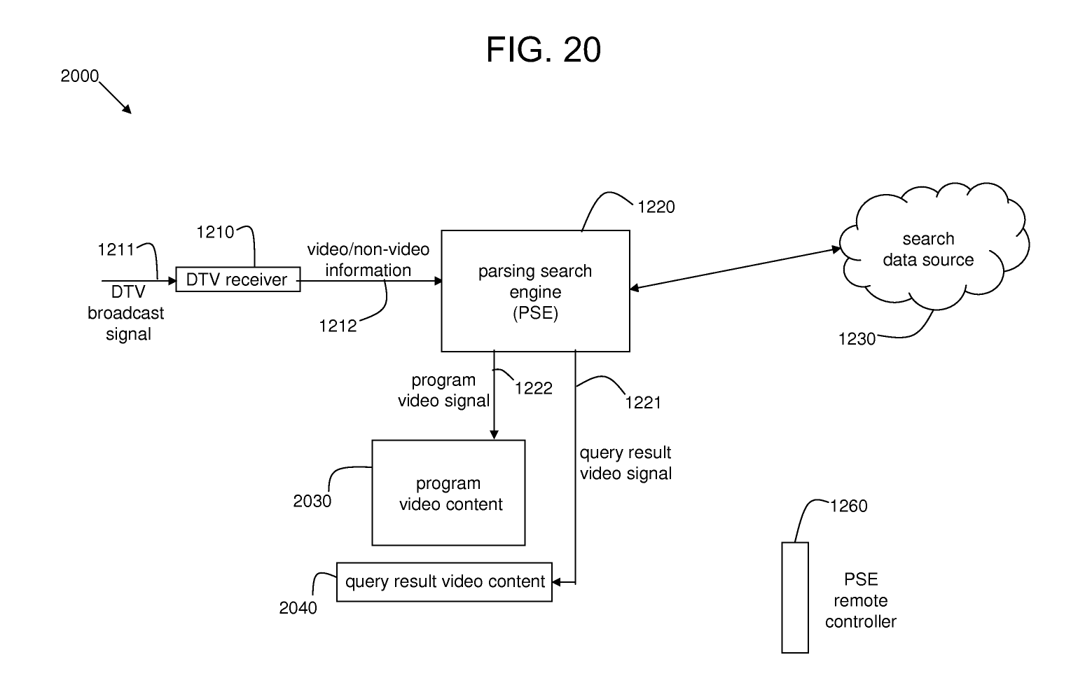

The program video signal 1222 and the query result video signal 1221 may each be sent to the VCC 1240 to be combined into a single composite video signal 1241 as previously described herein. Alternatively, the program video signal 1222 may be sent to a first display and the query result video signal 1221 may be sent to a second display (see FIG. 20).

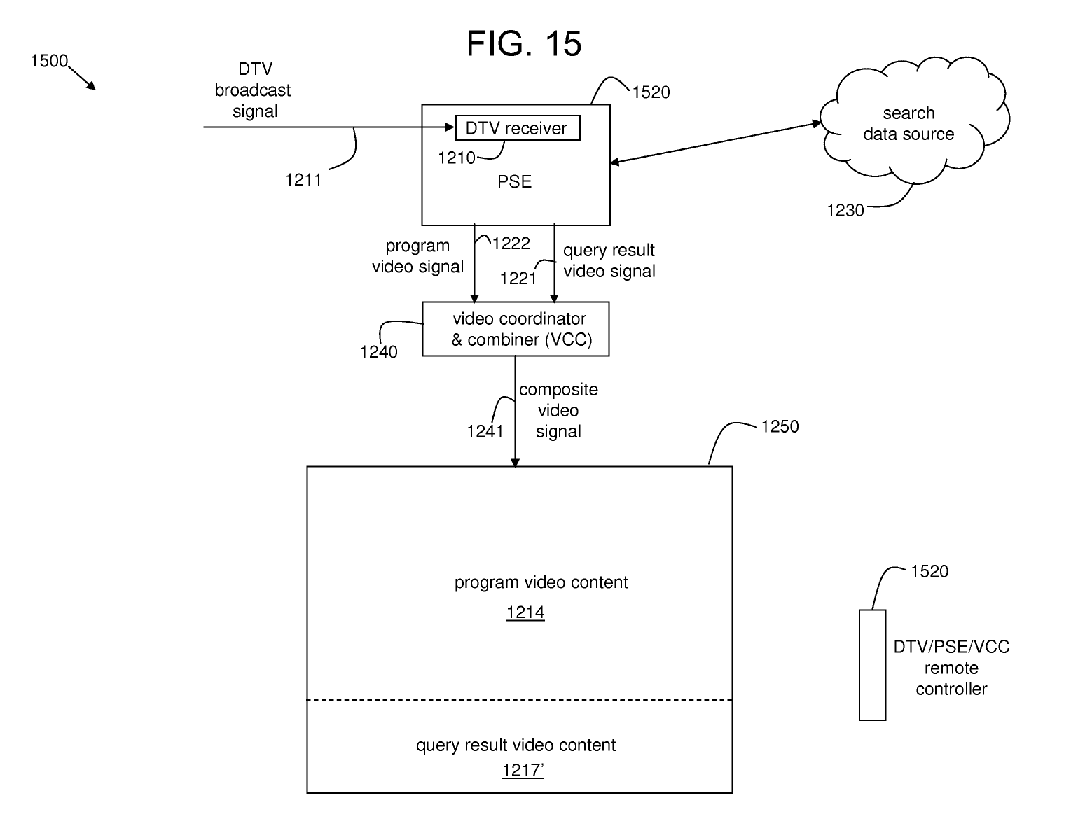

FIG. 15 illustrates a schematic block diagram of a second embodiment of a system 1500 for acquiring search content based on digital information content provided from a video source. System 1500 is somewhat similar to system 1200 of FIG. 12 except that, in this embodiment, the functionality of the DTV receiver 1210 previously described herein is integrated into PSE 1520. In this embodiment, PSE 1520 receives the DTV broadcast signal 1211, processes the DTV Broadcast signal 1211, and generates the video/non-video information (not shown) within the PSE 1520. The single remote controller 1560 may be used to control the remote controllable functions of the VCC 1240, the PSE 1520 and the DTV receiver integrated therewith.

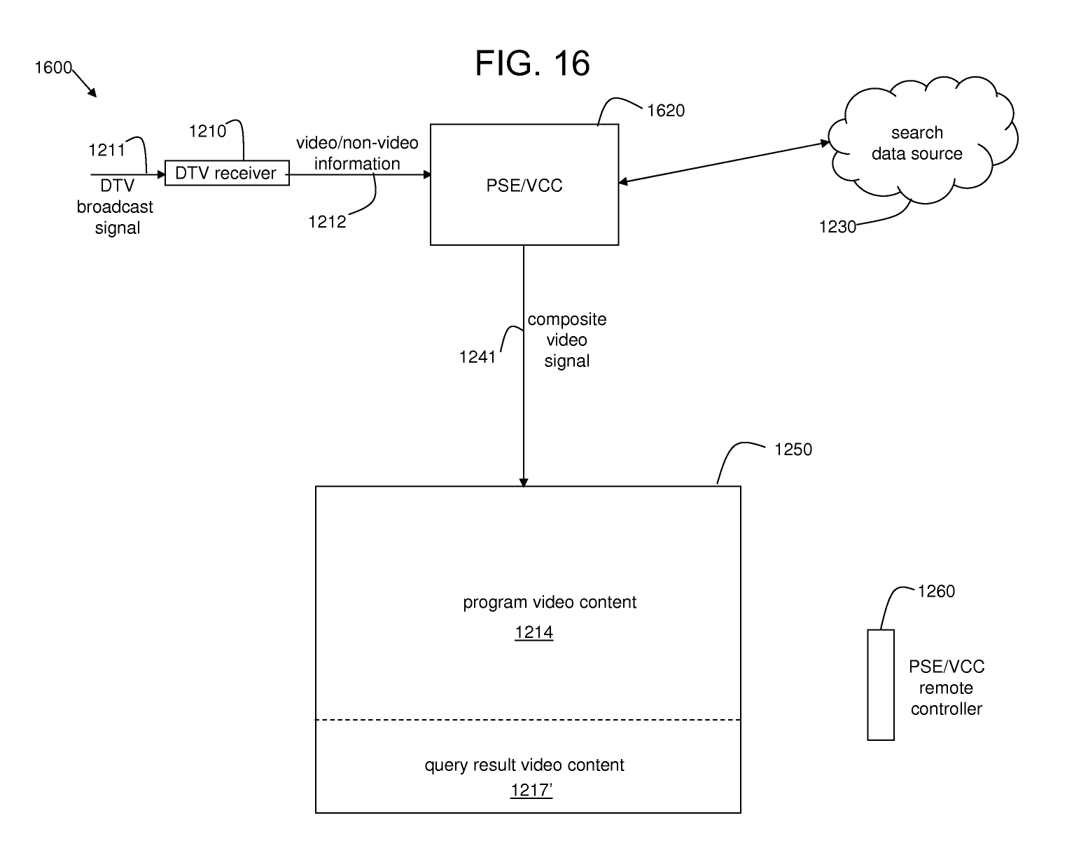

FIG. 16 illustrates a schematic block diagram of a third embodiment of a system 1600 for acquiring search content based on digital information content provided from a video source. System 1600 is somewhat similar to system 1200 of FIG. 12 except that, in this embodiment, the functionality of the VCC 1240 as previously described herein is integrated into PSE 1620. Therefore, in this embodiment, the program video signal (not shown) and the query result video signal (not shown) are combined into a single composite video signal 1241 within PSE 1620.

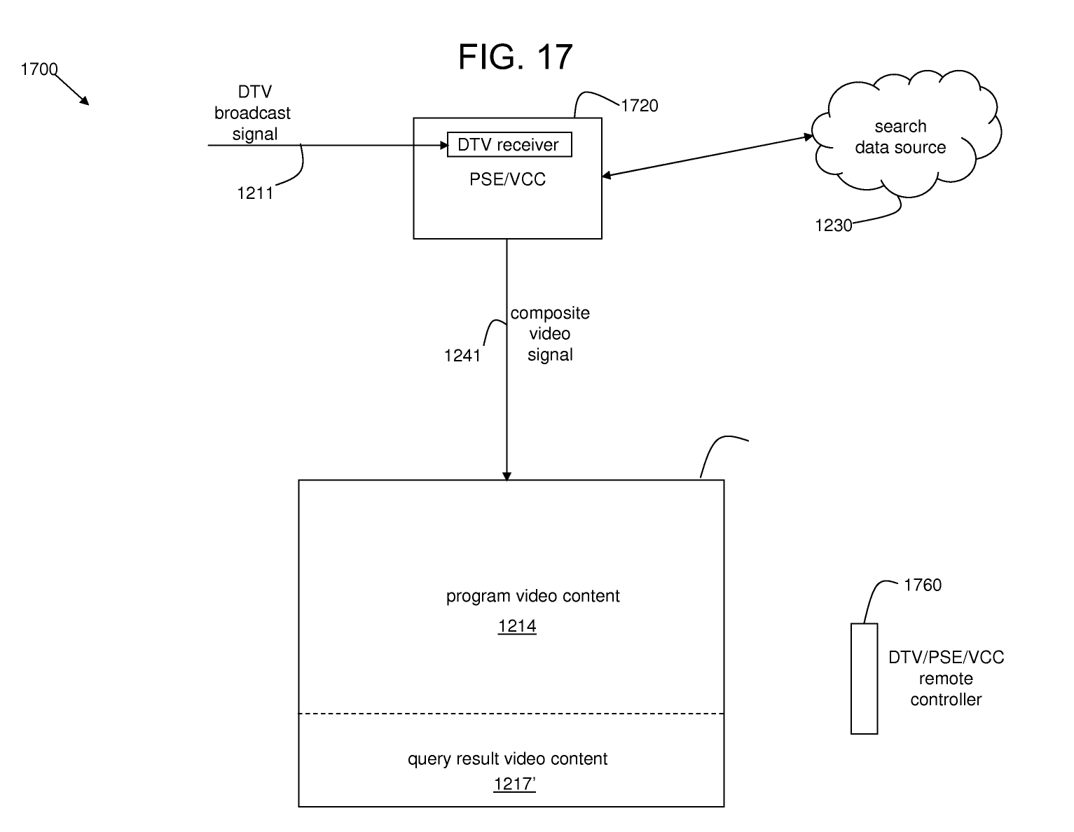

FIG. 17 illustrates a schematic block diagram of a fourth embodiment of a system 1700 for acquiring search content based on digital information content provided from a video source. System 1700 is somewhat similar to system 1200 of FIG. 12, system 1500 of FIG. 15, and system 1600 of FIG. 16 except that, in this embodiment, the functionality of the DTV receiver 1210 and the VCC 1240 previously described herein are integrated into PSE 1720. In this embodiment, PSE 1720 receives and processes DTV broadcast signal 1211, and combines program video signal (not shown) and query result video signal (not shown) into the single composite video signal 1241. The single remote controller 1760 may be used to control all of the remote controllable functions of the PSE 1720 and the DTV receiver and VCC integrated therewith.

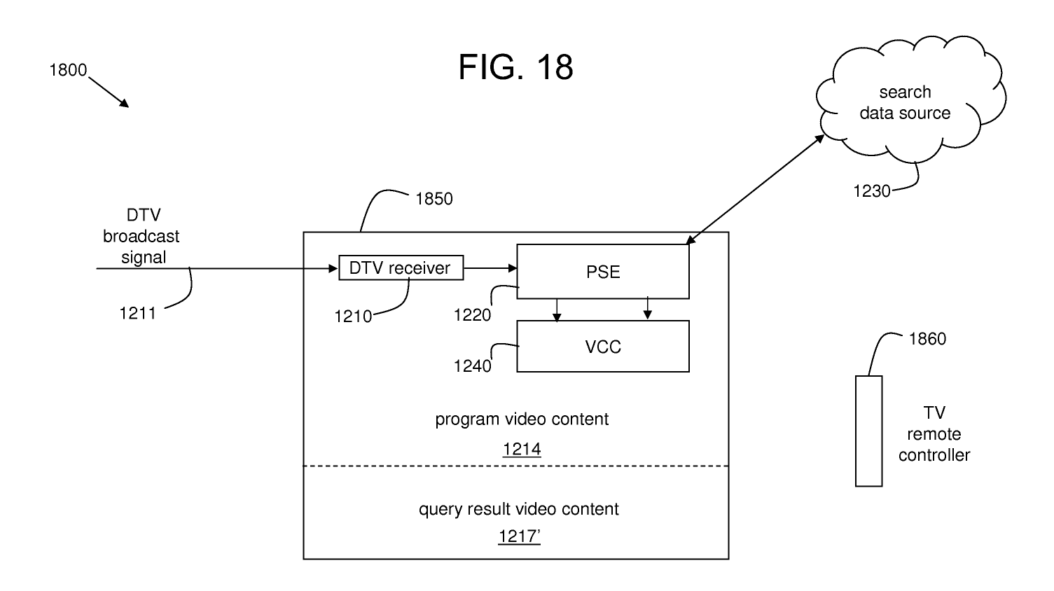

FIG. 18 illustrates a schematic block diagram of a fifth embodiment of a system 1800 for acquiring search content based on digital information content provided from a video source. System 1800 is somewhat similar to system 1200 of FIG. 12 except that, in this embodiment, the functionality of the DTV receiver 1210, the VCC 1240, and the PSE 1220 are integrated with video display 1250 to form a single integrated television set 1850. Therefore, the television set 1850 receives and processes the DTV broadcast signal 1211 within the television set 1850, and generates and displays the program video content 1214 and the query result video content 1217′. The remote controller 1860 is a TV remote controller used to control all of the remote controllable functionality of the DTV receiver, PSE, and VCC integrated within the TV set 1850.

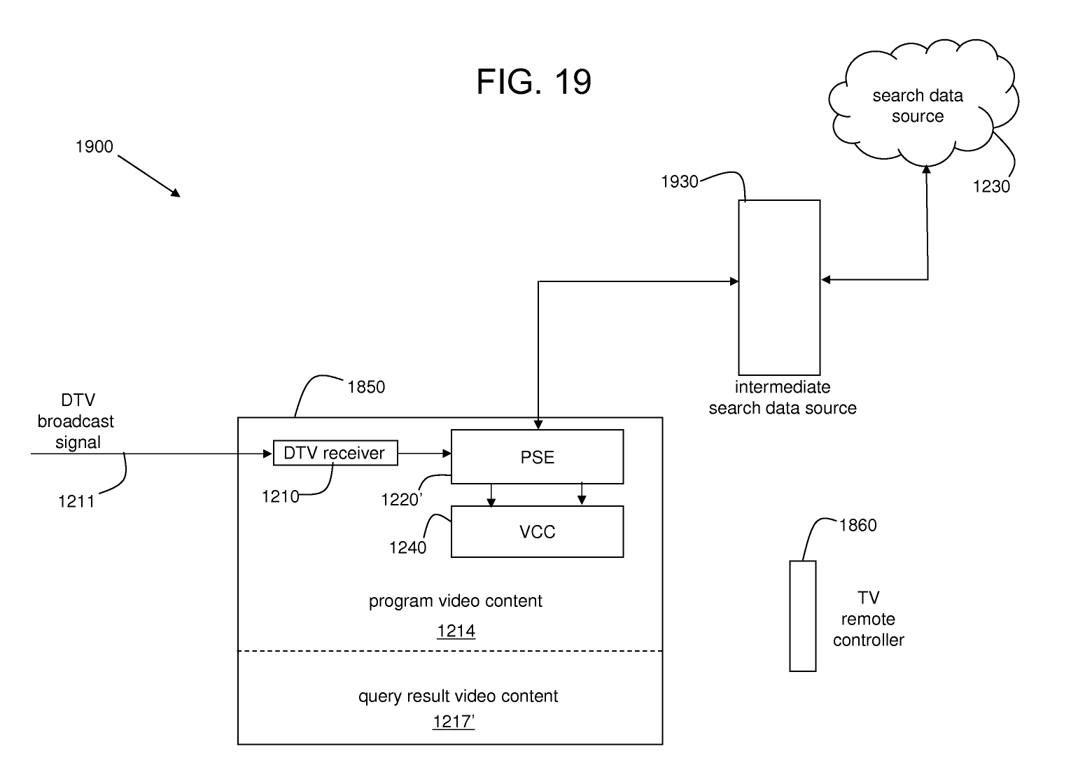

FIG. 19 illustrates a schematic block diagram of a sixth embodiment of a system 1900 for acquiring search content based on digital information content provided from a video source. System 1900 is somewhat similar to system 1800 of FIG. 18 except that, in this embodiment, an intermediate search data source 1930 serves as an intermediary device in system 1900. The intermediate search data source 1930 may be, for example, a personal computer, a workstation, a server, a database, or any other device capable of processing data known to a person of ordinary skill in the art, and chosen with sound engineering judgment. In this embodiment, the television set 1850 communicates a search query to the intermediate search data source 1930, which communicates at least one query result from the search data source 1230 based on the search query to the television set 1850. The television set 1850 then processes the at least one query result, generates and displays the program video content 1214 and query result video content 1217′.

In accordance with an embodiment of the present invention, the intermediate search data source 1930 provides a web browser functionality, alleviating the PSE 1220′ from having to provide such web browser functionality. In accordance with another embodiment of the present invention, the intermediate search data source 1930 provides a web browser functionality and the functionality of analyzing the query results and pulling out or extracting the desired information as query result display data, based on pre-programmed preferences or user-selected preferences and providing the query result display data to the integrated PSE 1220′ of the television set 1850. Therefore, the functionality of the integrated PSE 1220′ may be simplified compared to the functionality of the PSE 1220 of FIG. 12 by using an intermediate search data source 1930.

In accordance with an embodiment of the present invention, the intermediate search data source 1930 is located remotely from the television set 1850. For example, the intermediate search data source 1930 may be located at a third party site which provides an intermediate search data source service to customers. In accordance with another embodiment of the present invention, the intermediate search data source 1930 may be co-located with the television set 1850, for example, in the home of a user.

FIG. 20 illustrates a schematic block diagram of a seventh embodiment of a system 2000 for acquiring search content based on digital information content provided from a video source. System 2000 is somewhat similar to system 1200 of FIG. 12 except that, in this embodiment, PSE 2020 provides the program video signal 1222 and the query result video signal 1221 to individual video displays 2030 and 2040, respectively. Therefore, the need to combine the program video signal 1222 and the query result video signal 1221 using a VCC 1240 is unnecessary. Each signal is displayed on its own video display, and may be controlled by a PSE remote controller 2060.

Other various integrated and combinatorial embodiments may be possible as well as would be apparent to one skilled in the art after understanding the embodiments disclosed herein with respect to the drawings.

In summary, apparatus, methods, and systems for acquiring search content based on digital information content provided from a video source are disclosed. Video information and associated non-video information are received from a video source. The video information includes program video content and the associated non-video information includes digital information content. At least a portion of the digital information content is transformed into a search query and the search query is communicated to a first search data source. A query result is received from the first search data source based on the search query. At least a portion of the search query results are transformed into query result display data which may then be encoded as a video signal for display.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. An apparatus for acquiring search content based on digital information content provided from a video source, said apparatus comprising:
(a) means for receiving video information and associated non-video information from a video source, wherein said video information includes program video content and said associated non-video information includes digital information content;
(b) means for processing said digital information content to generate a search query;
(c) means for communicating said search query to a first search data source; and
(d) means for receiving at least one query result from said first search data source based on said search query.

2. The apparatus of claim 1 further comprising means for parsing said digital information content from said video information and associated non-video information.

3. The apparatus of claim 1 further comprising:
(f) means for processing said at least one query result to generate query result display data; and
(g) means for generating a query result video signal encoded with said query result display data.

4. The apparatus of claim 3 further comprising means for outputting said query result video signal and means for outputting a program video signal having said program video content.

5. The apparatus of claim 4 wherein said program video signal comprises a video data channel received from said video source as said video information and associated non-video information.

6. The apparatus of claim 4 wherein said program video signal is derived from a video data channel received from said video source.

7. The apparatus of claim 4 further comprising means for displaying said program video signal and said query result video signal.

8. The apparatus of claim 4 further comprising means for combining said program video signal and said query result video signal into a single composite video signal.

9. The apparatus of claim 8 further comprising means for displaying said single composite video signal.

10. The apparatus of claim 1 further comprising means for receiving remote control commands from an external remote control device.

11. A method for acquiring search content based on digital information content provided from a video source, said apparatus comprising:
(a) receiving video information and associated non-video information from a video source, wherein said video information includes program video content and said associated non-video information includes digital information content;
(b) transforming at least a portion of said digital information content into a search query;
(c) communicating said search query to a first search data source; and
(d) receiving at least one query result from said first search data source based on said search query.

12. The method of claim 11 further comprising parsing said digital information content from said video information and associated non-video information.

13. The method of claim 11 further comprising:
(f) transforming at least a portion of said at least one query result into query result display data; and
(g) generating a query result video signal encoded with said query result display data.

14. The method of claim 13 further comprising outputting said query result video signal and outputting a program video signal having said program video content.

15. The method of claim 14 wherein said program video signal comprises a video data channel received from said video source as said video information and associated non-video information.

16. The method of claim 14 wherein said program video signal is derived from a video data channel received from said video source.

17. The method of claim 14 further comprising displaying said program video signal and said query result video signal.

18. The method of claim 14 further comprising combining said program video signal and said query result video signal into a single composite video signal.

19. The method of claim 18 further comprising displaying said single composite video signal.

20. The method of claim 11 further comprising remotely influencing said transforming step via a remote control device.

21. A system for acquiring search content based on digital information content provided from a video source, said system comprising:
(a) a digital television (DTV) receiver capable of receiving a digital television broadcast signal and demodulating said digital television broadcast signal to extract a digital video data channel including a digital video sub-channel encoded with digital video content and a digital information sub-channel encoded with digital information content;
(b) a parsing search engine (PSE) operatively connected to said digital television receiver and capable of receiving said digital video data channel, generating a search query based on said digital information content, and receiving at least one query result based on said search query; and
(c) a video coordinator and controller (VCC) operatively connected to said parsing search engine and capable of receiving a digital video signal and a query result video signal from said parsing search engine, wherein said digital video signal is encoded with said digital video content and said query result video signal in encoded with at least a portion of said at least one query result, and capable of generating a composite video signal from said digital video signal and said query result video signal.

22. The system of claim 21 further comprising a first search data source operatively connected to said parsing search engine and capable of providing said at least one query result based on said search query.

23. The system of claim 22 further comprising an intermediate search data source operatively connected between said parsing search engine and said first search data source, and capable of passing said search query from said parsing search engine to said first search data source, editing said at least one query result received from said first search data source to generate an edited query result, and providing said edited query result to said parsing search engine.

24. The system of claim 21 further comprising a display device capable of receiving and displaying said composite video signal.

25. The system of claim 21 further comprising a remote controller device capable of allowing a user to remotely control at least one of said parsing search engine (PSE), said video coordinator and combiner (VCC), and said digital television (DTV) receiver.

26. The system of claim 21 wherein said digital television receiver includes one of a digital terrestrial television receiver, a digital cable television receiver, a digital satellite television receiver, a digital microwave television receiver, and an internet protocol television receiver.
